(19) United States
(12) Patent Application Publication
(10) Pub. No.: US 2017/0286989 A1
(43) Pub. Date: Oct. 5, 2017

(54) CUSTOMER GROUPS AND SALES PROMOTIONS

(71) Applicant: Square, Inc., San Francisco, CA (US)

(72) Inventors: Phil Zigoris, San Francisco, CA (US); Abhay Sukumaran, San Francisco, CA (US); Steve Conover, San Francisco, CA (US)

(21) Appl. No.: 15/087,774

(22) Filed: Mar. 31, 2016

(51) Int. Cl. G06Q 30/02

(52) U.S. Cl. CPC G06Q 30/0233; G06Q 30/0238

(57) ABSTRACT

An online transaction processing service may be used by a merchant to process payments for purchase transactions. The service may also support the merchant in other ways, such as by managing sales promotions and points-based loyalty programs. The service is configured to recommend the number of points to be redeemed for a particular sales promotion. The recommendation may be based on promotional goals of the merchant, on the number of reward points held by the customers of the merchant, on historical redemption rates by qualifying customers, etc.

### BACKGROUND

Merchants may use various types of mechanisms for promoting their products, including temporary product discounts and loyalty programs. However, it is not always easy for a merchant to know the types or parameters of promotions may be most beneficial in terms of promoting sales, profitability, and customer loyalty.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram illustrating a merchant support environment, including a transaction processing service that recommends sales promotions.

FIG. 2 is a flow diagram illustrating an example method for providing sales promotions to customer groups.

FIG. 3 is a flow diagram illustrating an example method for formulating a sales promotion.

FIG. 4 is a flow diagram illustrating an example method for generating sales promotions in response to customer visits to a merchant.

FIG. 5 is a flow diagram illustrating an example method for recommending price discounts and reward point numbers for use in sales promotions.

FIG. 6 is a block diagram of an example point-of-sale device that may be used in the merchant support environment of FIG. 1.

FIG. 7 is a block diagram of an example server computer, of which one or more may be used to implement the transaction processing service of FIG. 1.

### DETAILED DESCRIPTION

A merchant may utilize the services of an online transaction processing service for conducting purchase transactions with customers and for processing payments by customers. The transaction processing service may provide services for a large number of merchants, and may include pricing services, inventory services, payroll services, and other integrated services.

The transaction processing service stores historical transaction data regarding individual purchase transactions. The transaction data may indicate various information about a transaction, including the identity of the purchasing customer, the items purchased, and the prices of the items. The transaction data may include data regarding transactions conducted by multiple merchants.

The transaction processing service analyzes the transaction data to identify a merchant's customers who are members of different customer groups, wherein each customer group is defined by one or more purchasing behaviors of its members. For example, one group may include recent first-time customers of a merchant. Another group may include customers who predominantly purchase a certain category of products, such as sporting goods as an example, from the merchant.

The transaction processing service may select a customer group and may recommend to the merchant that a sales promotion be directed to the members of the customer group. The transaction processing service may also formulate and recommend a particular sales promotion to be directed to the members of the customer group, based on past behaviors of the group, on merchant inventory conditions, on preferences and sales priorities of the merchant, etc.

The transaction processing service may implement a loyalty program on behalf of a merchant, in which reward points are awarded to customers for purchases from the merchant. Sales promotions may be based on redemptions or awards of reward points.

The system may provide promotion recommendations to a merchant, wherein such a recommendation indicates a combination of a price discount for a product and a number of reward points that are to be redeemed by a customer in order to obtain the price discount. The price discount and the number of reward points may be determined based on factors including, but not limited to: (a) a sales goal specified by the merchant; (b) promotion parameters specified by the merchant; (c) a maximum promotion investment specified by the merchant; (d) the purchase price or cost to the merchant of the product offered in the sales promotion; (e) the undiscounted price of the product; (f) the numbers of reward points held by individual customers of the merchant; (g) historical redemption rates by customers of the merchant and by customers of other merchants for similar products; (h) types of customers to be targeted by the promotion; and so forth.

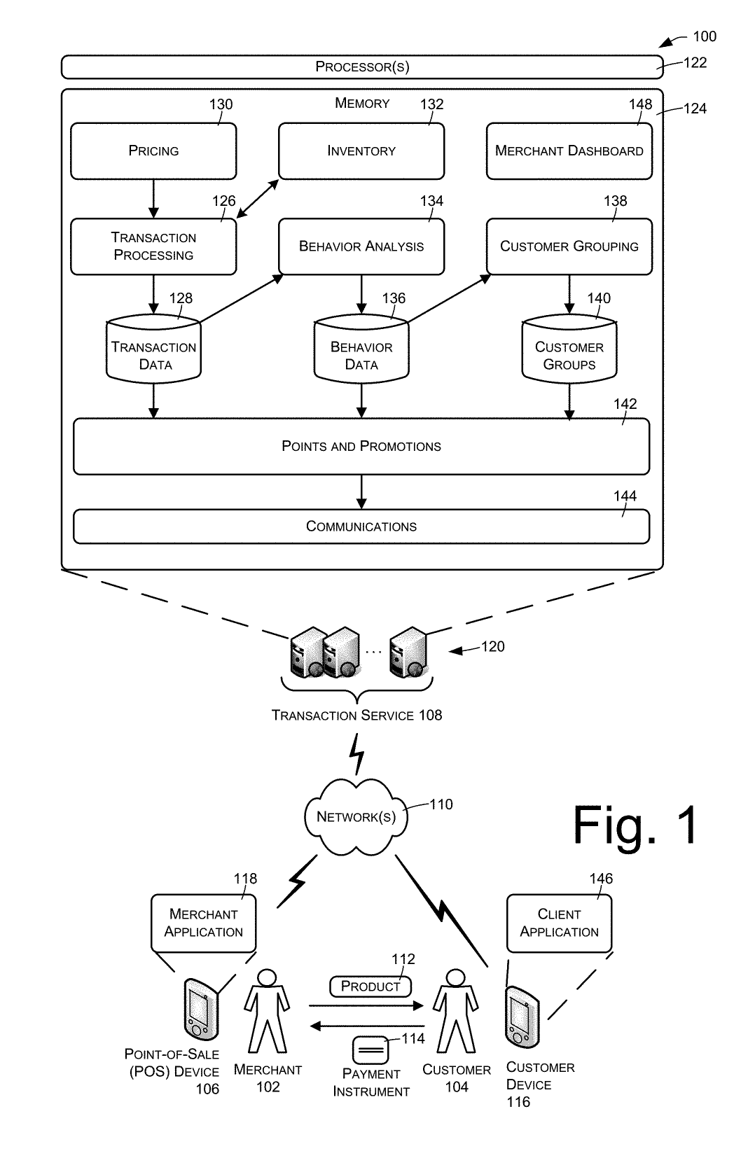

FIG. 1 illustrates an example system 100 that conducts purchase transactions between merchants and customers. For purposes of discussion, FIG. 1 shows a single merchant 102 and a single customer 104. The merchant 102 has an associated point-of-sale (POS) device 106 that is supported by an online transaction processing system 108, which is also referred to herein as a transaction service 108. The POS device 106 communicates with the transaction service 108 through a wide-area network (WAN) 110, such as the public Internet, using secure communication protocols. The transaction service 108 processes purchase transactions on behalf of the merchant 102. In practice, the transaction service 108 may process purchase transactions on behalf of multiple merchants 102.

The merchant 102 and the customer 104 interact with each other to complete a purchase transaction in which the customer 104 acquires a product 112 from the merchant 102, and in return, the customer 104 provides payment to the merchant 102. The term “transaction” includes any interaction for the acquisition of a product in exchange for payment. The term “product” is understood to include goods and/or services. The term “customer” includes any entity that acquires products from a merchant, such as by purchasing, renting, leasing, borrowing, licensing, or the like. The term “merchant” includes any business engaged in the offering of products for acquisition by customers. Actions attributed to a merchant may include actions performed by owners, employees, or other agents of the merchant.

The customer 104 may provide payment using cash or another payment instrument 114 such as a debit card, a credit card, a stored-value or gift card, a check, etc. Payment may also be made through an electronic payment application on a customer mobile device 116, such as a smartphone carried by the customer 104.

When the customer 104 and the merchant 102 enter into an electronic purchase transaction, the merchant 102 interacts with the POS device 106 to provide payment information and identification of products that are being purchased. For example, the merchant may input (e.g., manually, via a magnetic card reader or an RFID reader, etc.) a credit card number or other identifier of the payment instrument 114. For example, the payment instrument 114 may include one or more magnetic strips for providing card and customer information when swiped in a card reader associated with the POS device 106. In other examples, other types of payment instruments may be used, such as smart cards having built-in memory chips that are read by the POS device 106 when the cards are “dipped” into the reader, smart cards having radio frequency identification devices (RFIDs), and so forth.

More generally, purchase transaction information may include an identifier of the payment instrument (such as a credit card number and associated validation information); an identification of a card network associated with the payment instrument; an identification of an issuing bank of the payment instrument; an identification of a customer with whom the purchase transaction is being conducted; a total amount of the purchase transaction; the products acquired by the customer in the purchase transaction; the purchase prices of the individual products; the time, place, time, and date of the purchase transaction; the product category of each purchased product; and so forth. The POS device 106 sends the transaction information to the transaction service 108 over the network 110, either contemporaneously with the conducting of the transaction (in the case of online transactions) or later when the POS device 106 is online.

The transaction service 108 processes a purchase transaction by electronically transferring funds from a financial account associated with the customer 104 to a financial account associated with the merchant 102. The transaction service 108 may communicate with one or more computing devices of a card network (or “card payment network”), e.g., MasterCard®, VISA®, over the network 110 to conduct financial transactions electronically. The transaction service 108 can also communicate with one or more computing devices of one or more banks, processing/acquiring services, or the like over the network 110. For example, the transaction service 108 may communicate with an acquiring bank, and/or an issuing bank, and/or a bank maintaining customer accounts for electronic payments.

An acquiring bank may be a registered member of a card association (e.g., Visa®, MasterCard®), and may be part of a card payment network. An issuing bank may issue credit cards to buyers, and may pay acquiring banks for purchases made by cardholders to which the issuing bank has issued a payment card. Accordingly, in some examples, the computing device(s) of an acquiring bank may be included in the card payment network and may communicate with the computing devices of a card-issuing bank to obtain payment. Further, in some examples, the customer 104 may use a debit card instead of a credit card, in which case, the bank computing device(s) of a bank corresponding to the debit card may receive communications regarding a transaction in which the customer is participating. Additionally, there may be computing devices of other financial institutions involved in some types of transactions or in alternative system architectures, and thus, the foregoing are merely several examples for discussion purposes.

The transaction service 108 may also be configured to provide electronic receipts to purchasing customers after completed purchase transactions. For example, during a transaction the customer 104 may provide an email address, which is in turn provided to the transaction service 108. Upon completing the purchase transaction, the transaction service 108 may send a receipt for the purchase transaction to the provided email address of the customer 104.

In some cases, the transaction service 108 may also implement a near-real-time feedback system, in which customers are solicited by email or other electronic communications to provide real-time or near-real-time ratings or evaluations of purchased products. For example, an email containing a transaction receipt may also include a link to a website where a customer may provide a simple rating for the transaction and/or the products involved in the transaction. Alternatively, the email itself may have graphical elements that can be selected to provide product/service ratings. A graphical element corresponding to a “4-star” rating, for example, may be associated with a hyperlink that effectively communicates the rating to the transaction service 108. Other forms of electronic communications may also be used for this purpose, such as text messaging, social network messaging, etc.

The POS device 106 may comprise any sort of mobile or non-mobile device. An instance of a merchant application 118 executes on the POS device 106. The merchant application 118 provides POS functionality to the POS device 106 to enable the merchant 102 to accept payments from the customer 104.

In some types of businesses, the POS device 106 may be located in a store or other place of business of the merchant 102, and thus may be at a fixed location that does not change on a day-to-day basis. In other types of businesses, however, the location of the POS device 106 may change from time to time, such as in the case that a merchant operates a food truck, is a street vendor, is a cab driver, etc., or has an otherwise mobile business, e.g., in the case of merchants who sell products at buyer's homes, places of business, and so forth.

The transaction service 108 may be implemented by one or more server computers 120 and associated software components that provide the functionality described herein. For purposes of discussion, a server computer 120 is represented in FIG. 1 as one or more processors 122 and associated memory 124, wherein the memory 124 stores software components and associated data. The software and software modules described herein may comprise programs, routines, functions, and other executable instructions and software components. The server computers 120 may be part of a data center or server farm, and collectively may provide transaction processing services for large numbers of merchants.

The transaction service 108 implements a transaction processing module 126 that is responsible for processing payment transactions between the customer 104 and the merchant 102. The transaction processing module 126 stores transaction data 128 indicating, for each of multiple completed purchase transactions, one or more of the following:
an identifier of the payment instrument used for the purchase transaction;
a card network associated with the payment instrument;
an issuing bank of the payment instrument,
an identification of a customer with whom the purchase transaction was conducted;
a time and place of the purchase transaction;
a total amount of the purchase transaction;
a product purchased in the purchase transaction;
a purchase price of the product;
number of reward points redeemed as part of the purchase transaction for individual products;
a category of the product; and
any additional information that is generated as part of the purchase transaction.

The transaction processing module 126 may include or may work in concert with a pricing module 130 and an inventory module 132. The pricing module 130 maintains information on the prices of products sold by the merchant 102. When processing a transaction, the transaction processing module 126 references the pricing module 130 to determine the prices of the products of the transaction.

The inventory module 132 maintains information regarding inventory levels and counts of the products sold by the merchant 102. When processing a transaction, the transaction processing module 126 may indicate sold products to the inventory module 132, and the inventory module 132 may remove the sold products from the inventory counts of the merchant 102.

The transaction service 108 implements a behavior analysis module 134 that analyzes the transaction data 128 to characterize customer purchasing behaviors. Recognized purchasing behaviors are stored as behavior data 136.

The behavior data 136 includes purchasing behaviors in terms of metrics that may include, without limitation:
times of purchase transactions conducted by the merchant with a particular customer;
a time range within which purchase transactions are predominantly conducted by the merchant with the particular customer;
categories of products purchased by the customer from the merchant;
an average price of products purchased by the customer from the merchant;
an average total transaction amount for purchase transactions conducted by the merchant with the customer;
total transaction amounts for purchase transactions conducted by the merchant with the customer during respective time periods;
a number of purchase transactions conducted by the merchant with the particular customer;
a number of products that are purchased by the customer from the merchant;
a number of relatively high-priced products that are purchased by the customer from the merchant;
a frequency of purchase transactions conducted by the merchant with the particular customer;
the time of the most recent purchase transaction conducted with the particular customer; and
a number of reward points of the particular customer.

The behavior data 136 is stored for each merchant, and indicates data for each of multiple customers of the merchant.

The transaction service 108 may also implement a customer grouping module 138 that analyzes the behavior data 136 to produce customer group data 140. The customer group data specifies groups of customers of the merchant 102 who exhibit similar purchasing behaviors. For example, the group data 140 may indicate a group of customers who are the merchant's most frequent purchasers. As another example, the group data 140 may indicate a group of customers who typically purchase the highest-priced products from the merchant. As yet another example, the group data 140 may indicate a group of recent first-time customers of the merchant.

Types and/or combinations of purchasing behaviors that define different customer groups may be specified by the transaction service 108 and/or by the merchant 102. For example, the customer grouping module 138 may be configured to identify groups that include, without limitation:
the customers of the merchant who have predominantly purchased the highest-priced products from the merchant;
customers who predominantly visit the merchant during peak business hours;
customers who predominantly purchase certain products or product categories;
customers who are the most frequent purchasers of the merchant;
customers who most frequently visit the merchant;
customers who have most recently visited the merchant;
customers who have not recently visited the merchant;
customers who purchase the highest number of products from the merchant; and
customers whose purchases predominantly fall within a given price range.

The above list is not exhaustive, and customer groups may be defined based on various different customer behaviors. Furthermore, a customer group may be defined based on a combination of different customer behaviors. For example, a group may comprise those customers who are frequent purchasers and who predominantly make small purchases during each visit. As another example, a group may comprise those customers whose purchases predominantly fall within a given price range and who do not purchase certain categories of products.

In some embodiments, the customer grouping module 138 may use statistical data clustering techniques to identify clusters of customers having similar combinations of behaviors, rather than relying on predefined definitions of customer groups.

The transaction service 108 may implement a points and promotions module 142 that implements a points-based loyalty program in which participating customers receive reward points in response to activities conducted with the merchant, such as purchases from the merchant and visits to the merchant. For example, the customer 104 may be awarded points in proportion to the transaction amounts of purchases by the customer 104 from the merchant 102. Alternatively, or in addition, the customer 104 may be awarded points in proportion to numbers of products purchased, numbers of visits to the merchant 102, etc. Reward points may be redeemed for discounts on specified products under terms specified and/or approved by the merchant 102.

The points and promotions module 142 also implements and manages sales promotions. Sales promotions may include limited-time discounts on products, groups of products, categories of products, etc. Sales promotions may comprise simple discounts or may comprise conditional discounts, such as discounts that apply after purchasing a minimum number or value of products. Sales promotions may also involve the exchange of reward points, such as promotions that grant bonus reward points for certain types of purchases or promotions that are redeemable using reward points. The points and promotions module 142 keeps track of awards and redemptions of reward points, as well as keeping track of the number of points held by each of the merchant's customers at any given time. In some embodiments, the points and promotions module 142 may maintain an account for each customer, indicating the current number of reward points held by the customer.

The transaction service 108 may have a communications component 144 that implements electronic communications with customers, such as email, text message, social messaging communications, etc. The communications component 144 may also communicate with the customer 104 through a dedicated-purpose client application 146 that executes on the customer device 116. For example, such a client application 146 may be designed and provided by the merchant 102 to provide ordering and shopping services as well as to inform the customer 104 regarding current reward point balances.

The points and promotion module 142 may work in conjunction with the customer grouping module 138 to formulate and recommend sales promotions for particular groups of customers. The points and promotions module 142 may also be responsive to the pricing module 130 and the inventory module 132 when formulating promotions.

The transaction service 108 may further implement a merchant dashboard 148, comprising a user interface that is accessible to the merchant 102 for specifying inventory, for specifying prices of inventory products, and for configuring other aspects of the services provided for or on behalf of the merchant 102 by the transaction service 108. The merchant dashboard 148 may be a website that is accessible through the network 110 or may be functionality that is accessible through the merchant application 118 of the POS device 106.

Although various functionality is described above as being implemented by respective software modules for purposes of clarity, the functionality attributed herein to the transaction service 108 may be implemented using various different components, entities, and organizational architectures. In the following, certain functionality will be described generally as being performed by the transaction service 108, with only occasional reference to specific software components of the transaction service 108, although it should be understood that the described functionality may in some implementations be implemented by specific modules or entities as described above.

In operation, the transaction service 108 receives data from the POS device 106 of the merchant 102 and generates transaction data, such as the transaction data 128 described above. The transaction service 108 analyzes the transaction data to determine purchasing behaviors of individual customers. In the context of FIG. 1, such purchasing behaviors may be indicated by the behavior data 136.

The transaction service 108 analyzes the purchasing behaviors to identify groups or clusters of customers who have similar purchasing behaviors with respect to the merchant 102, in order to identify customer groups that might respond favorably to different sales promotions. In some embodiments, the transaction service 108 may also formulate a sales promotion that is likely to be effective for a particular group of customers, based on the purchasing behaviors of those customers. Such a sales promotion may then be suggested or recommended to the merchant 102. Assuming that the merchant 102 approves of the recommended sales promotion, the transaction service 108 sends a notification to customers of the group, describing the sales promotion.

In addition to identifying groups of customers, the transaction service 108 may determine which customer groups or types of customer groups may be most relevant to the merchant 102, and may identify or formulate sales promotions to be offered specifically to those groups. Different types of merchants may have different priorities, for example, and focusing on the most appropriate customer groups may at times be important in addressing those priorities.

As an example, it may be desirable for some types of businesses to strive for a steady and uniform customer flow in order to most efficiently utilize staff and/or production facilities. For these types of businesses, the transaction service 108 may identify a customer group comprising customers that predominantly visit the merchant at peak business hours, and may formulate a promotion that encourages these customers to visit during non-peak hours. For example, such a promotion may offer a discount for purchases during non-peak business hours.

As a different example, it may be desirable for a merchant to pay particular attention to those customers who spend the most or who purchase the most expensive products. For these types of merchants, the transaction service 108 may identify a customer group comprising those customers whose cumulative purchases are the highest or who purchase the highest priced products.

In some situations or embodiments, the transaction service 108 may determine relevant customer groups based on information provided by the merchant 102. For example, the merchant 102 may indicate its type of business and/or its sales priorities. As a result, the transaction service 108 may identify certain types of customer groups that the merchant 102 may wish to address in order to improve sales performance.

As a specific example, for a certain type of business such as a car dealership it may be useful to identify and incentivize those customers who purchase the highest priced cars. It may also be useful to identify and incentivize those customers who purchase cars more frequently and/or in higher volumes. A car dealership may want to provide different types of incentives for these different types of customers. As a contrasting example, a donut shop may find it useful to identify a group of customers who visit the shop every day, at a particular time of day. Such a donut shop may want to offer a particular type of promotion to such a customer, and a different type of promotion to customers who visited a single time but never returned.

The transaction service 108 may formulate and/or recommend specific sales promotions to the merchant 102. In some cases, sales promotions may be formulated and/or recommended for respective customer groups, and may be based on the purchasing behaviors of those groups. Formulating a sales promotion includes determining the product or product category that will be the subject of the sales promotion and determining a discount, reward, or other incentive for a purchase of the product or product category.

Determining the product or product category that will be the subject of a sales promotion may be performed based on the determined purchasing behaviors of a particular customer group, such as the products for which the members of the group have historically shown a preference. In some cases, a sales promotion may promote products that are the same or similar to products that the customers of the group have already purchased. In other cases, a sales promotion may promote products that the customers do not historically purchase, in an attempt to encourage customers to broaden their purchasing behaviors.

Determining the product or product category that will be the subject of a sales promotion may also, or alternatively, be performed based on the existing inventories of the product or product category, and/or on the profit margins associated with the product or product category. For example, a sales promotion may promote products that have relatively high inventories and/or that are becoming outdated. As another example, a sales promotion may promote products that have relatively high profit margins in order to increase sales margins of the merchant 102.

In some cases, a sales promotion may be formulated in order to encourage customer loyalty. For example, the transaction and behavior data may be analyzed to determine a product that, when purchased, is followed by repeat visits or purchases by the customer. Once such a product has been identified, that product may be included in future sales promotions, with the expectation that when a customer purchases that product it will lead that customer to become a loyal customer and to make repeated visits or purchase.

As yet another example, a sales promotion may be formulated to encourage purchase of a newly introduced product.

Sales promotions may be based on various types of formulas, which may or may not involve reward points. Examples of sales promotions include, without limitation:
a discount for a product;
a discount after purchasing a certain number of the product or when purchasing another product;
bonus reward points for purchase of a product;
discount for redemption of reward points;
etc.

A promotion may be based on groups or categories of products, rather than individual products, and may include or be conditional upon purchasing bundles or combinations of products or product categories. Sales promotions may also be time-based, such that they are effective only for a specified time period, for certain times of day, for certain times of the week, etc.

In embodiments that implement and support reward points through loyalty programs, a sales promotion may involve exchanging reward points with a customer. For example, a discount may be offered for redemption of a specified number of reward points. As another example, a sales promotion may specify an offer of bonus reward points for certain purchases.

In some embodiments the transaction service 108 may be configured to provide a recommendation to a merchant regarding the parameters of a sales promotion for a particular product or class of product. Specifically, the transaction service 108 may recommend a particular combination of a price discount and a number of reward points that are to be redeemable in order for a customer to obtain the discount. As an example, a merchant may specify one or more goals for a sales promotion and the transaction service 108 may formulate parameters of a sales promotion that are likely to achieve those goals. As an example of a goal, a merchant may specify that it wants to increase sales of a particular product or type of product by a certain number of units, or that the merchant wants to offer a promotion that will result in a specified number of promotion redemptions. As another example, the merchant may specify a target promotion cost or investment amount, corresponding to the cumulative monetary values or costs of discounts that are likely to be actually granted. Goal parameters may include other information such as whether a sales promotion will offer a free product or a discounted product, a particular discount or maximum discount to be offered, a particular product or product type to be offered as part of the promotion, a time period for the promotion, types or groups of customers to be targeted by the promotion, etc. In some cases, the merchant may specify the desired price discount, and the system may recommend the number of points required to obtain the discount based at least in part on how many points are held by individual customers of the merchant.

Based on the promotion goals specified by the merchant, the transaction service 108 may recommend one or both of a discount amount and a number of reward points that are to be redeemed in order to obtain the discount amount.

The recommendation by the transaction service 108 may be based on a variety of factors in order to meet the specified goals of the merchant. As an example, the transaction service 108 may analyze the number of reward points held by the customers of the merchant to determine how may customers will qualify to take advantage of a sales promotion that is offered for any given number of reward points. As a more specific example, suppose that the merchant has specified a goal of increasing sales by 100 units. In this case, the transaction service 108 may identify the 100 customers having the highest numbers of reward points and may recommend a number of redemption points that is less than the lowest number of reward points held by any one of these customers.

In actual practice, the transaction service 108 may also evaluate past promotions to determine an average redemption rate, and may account for this rate when determining the recommended number of redemption points. For example, past transaction data may indicate an average 50% conversion rate. That is, only 50% of qualifying customers typically take advantage of promotions for which they qualify by holding enough reward points. In this case, in order to meet the merchant goals the transaction service 108 may calculate the number of redemption points so that at least 200 customers qualify by having enough reward points to take advantage of the promotion, under the assumption that only 100 of the customers will actually redeem their reward points.

When determining a number of redemption points to be associated with a sales promotion, the transaction service 108 may analyze transaction data for transactions conducted by multiple merchants in order to predict a conversion rate. Such an analysis may be conducted separately for similar products, similar customer types, similar business types, similar seasons or times of day, etc., in order to accurately predict how many customers will actually respond to any particular sales promotion.

As mentioned, the transaction service 108 may recommend a number of reward points to be associated with a specified discount for a particular product or product type. In addition, in some embodiments the transaction service 108 may recommend a combination of a price discount and associated number of reward points. The price discount may be determined based on various factors, including but not limited to a maximum discount indicated by the merchant, the actual cost to the merchant of the involved products, the total cost or lost revenue likely to result from the promotion, the normal, undiscounted price of the product, etc. The discount may also be calculated based on an analysis of previous purchase transactions that were subject to similar sales promotions, in order to identify a discount that meets the promotion goals of the merchant. Such previous transactions may include transactions conducted by the merchant and transactions conducted by other merchants for similar types of products.

In certain embodiments the transaction service 108 may be configured to determine when the customer 104 has entered a business establishment of the merchant 102, and may determine a sales promotion and notify the customer 104 of the sales promotion upon determining that the customer 104 is at the business establishment. For example, the communications component 144 may send an email, text message, instant message, or other communication to the mobile device 116 of the customer 104, notifying the customer of a sales promotion that has been selected for the customer 104 or for a customer group of which the customer 104 is a member. In certain cases, the transaction service 108 may select a sales promotion that is specifically tailored to the identified customer or that is deemed to be particularly appropriate for the identified customer. For example, the transaction service 108 may analyze the customer's purchasing behaviors and may offer a sales promotion for products that include or that are similar to products previously purchased by the customer. As another example, the transaction service 108 may select or formulate a sales promotion based on the number of reward points currently held by the customer. Specifically, the transaction service 108 may select or formulate a sales promotion that involves redemption of a number of reward points, wherein the number of reward points is close to but less than the number of points currently held by the customer. Thus, both the product offered by the sales promotion and the number of reward points for redemption of the sales promotion may be based on the current number of points held by the customer.

In some embodiments, the transaction service 108 may utilize customer facing applications or websites to determine the presence of customers at a business establishment. For example, the customer mobile device 116 or the client application 146 running on the mobile device may be configured to detect when the customer 104 is at the business establishment using global positioning techniques or by detecting proximity beacons installed by the merchant 102 within the business establishment. In response to detecting that the customer 104 is at the business establishment, the mobile device 116 may automatically provide a notification to the POS device 106 or the transaction service 108.

As another example, customers may use social networking applications on their mobile devices and may voluntarily or automatically “check-in” at the business establishment. That is, the customer 104 may create a posting, using a social networking application, indicating the current location of the customer 104 at the business establishment. Certain merchants may provide incentives for such check-ins, such as discounts, rewards, or giveaways.

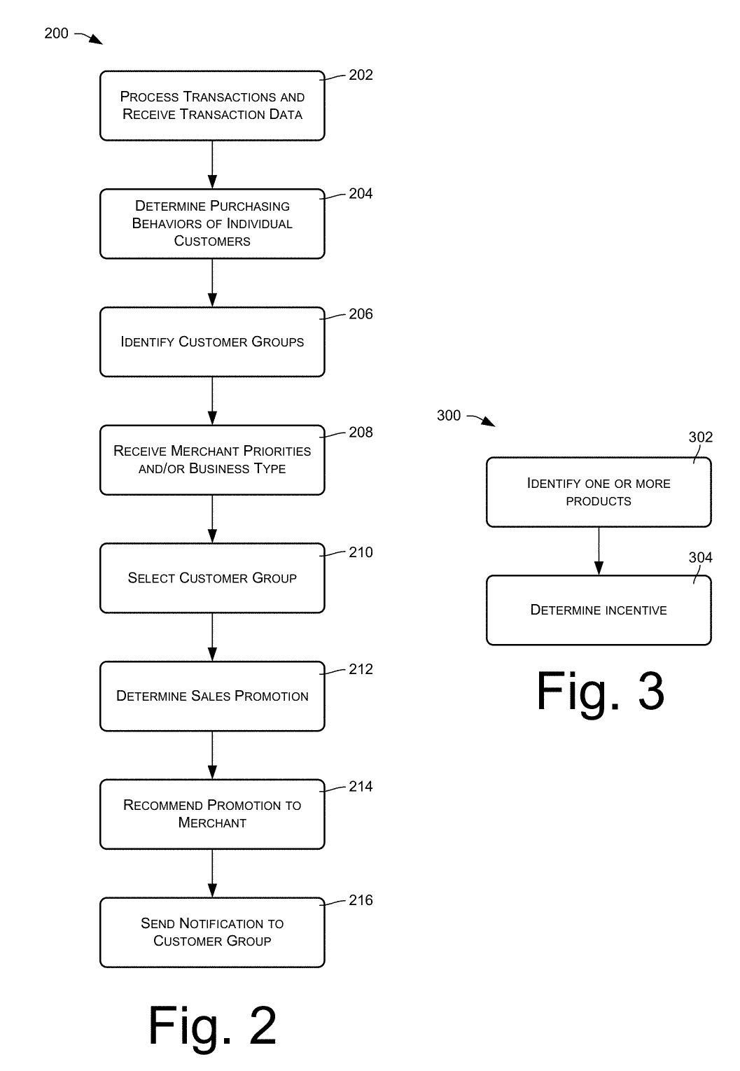

FIG. 2 illustrates an example method 200 for providing and offering sales promotions based on customer groups. The method 200 may be performed by the transaction service 108, although the described actions may also or alternatively be distributed between and performed by a combination of different entities, devices, and/or components.

An action 202 comprises processing purchase transactions, which may include receiving, creating, and storing transaction data. The action 202 may include, for example, receiving transaction data at the transaction service 108 from the POS device 106. The transaction data may also include data created and/or defined by the transaction service 108 as part of processing purchase transactions.

The transaction data may include various types of information regarding transactions, including but not limited to the following with respect to each of multiple purchase transactions:
an identification of a customer with whom the purchase transaction was conducted;
a time of the purchase transaction;
a transaction total amount;
a product purchased in the transaction;
a purchase price of the product;
a discount that was applied to the purchase of the product;
a number of reward points that were redeemed to obtain the discount; and
a category of the product.

An action 204 comprises analyzing the transaction data to determine purchasing behaviors of each customer. The determined purchasing behaviors of a particular customer may include one, two, or any number of behaviors, including but not limited to the following with respect to a particular customer:
times of purchase transactions conducted by the merchant with the particular customer;
categories of products purchased by the customer from the merchant;
prices of products purchased by the customer from the merchant;
total transaction amounts for purchase transactions conducted by the merchant with the customer;
total transaction amounts for purchase transactions conducted by the merchant with the customer during respective time periods;
a number of purchase transactions conducted by the merchant with the particular customer;
a frequency of purchase transactions conducted by the merchant with the particular customer;
a time of a most recent purchase transaction conducted with the particular customer; and
a number of reward points held by the particular customer.

An action 206 comprises analyzing the purchasing behaviors of multiple customers to identify or define one or more customer groups, where the members of each group have similar purchasing behaviors with respect to the merchant. In some cases, the action 206 may comprise selecting or defining one or more customer behaviors, and identifying a group of customers having the defined one or more customer behaviors. In some cases, the action 206 may comprise identifying a set of one or more of the purchasing behaviors that are similar among a group of customers and that therefore define a customer group. Such a set of purchasing behaviors, which define a customer group, may include at least one of the following, without limitation:
a time range within which purchase transactions are predominantly conducted by the merchant with the customers of the group;
a category of products that are predominantly purchased from the merchant by the customers of the group;
an average price of products purchased from the merchant by the customers of the group;
an average total transaction amount for purchase transactions conducted by the merchant the customers of the group;
a number of products that are purchased from the merchant by customers of the group;
a number of relatively high-priced products that are purchased from the merchant by customers of the group;
a number of purchase transactions conducted by the merchant with the customers of the group;
a frequency of purchase transactions conducted by the merchant with the particular customer; and
times of most recent purchase transactions conducted by the merchant by with the customers of the group.

In some cases, customer groups may be predefined based on corresponding behaviors, and customers exhibiting those behaviors may be identified as belonging to the respective groups. In other cases, customer groups may be defined by analyzing the behaviors using data clustering techniques to identify groups of customers whose purchasing behaviors are similar.

An action 208 comprises receiving an indication of the sales priorities and/or business type of the merchant. As an example of a sales priority, a merchant may indicate that its priority is to encourage visits of customers during otherwise non-peak hours. As another example, a merchant may indicate a priority of encouraging sales of products that are nearing the expiration of their shelf lives. As yet another example a merchant may indicate a priority of encouraging sales of products that are new to the inventory of the merchant. As examples of business types, a merchant may indicate types such as “fast food,” “clothing retailer,” “automobile repair shop,” etc.

An action 210 comprises selecting one or more of the identified customer groups that are likely to be of importance to the merchant, based on the merchant priorities and/or business type of the merchant. In some embodiments, associations may be predefined between (a) each merchant priority and business type and (b) a corresponding customer group definition. For example, a certain business type or merchant priority may be automatically associated with a certain customer group definition. As a more specific example, suppose that a merchant has indicated a priority of encouraging first-time visitors to make return visits. A corresponding customer group may comprise those customers that have recently visited the merchant for the first time and that have not yet returned.

An action 212 comprises selecting or determining a sales promotion for the selected customer group, wherein the sales promotion is selected so as likely to be effective for the customer group. As one example, the sales promotion may be based on the historical purchasing behaviors of members of the customer group, and may be for products that are similar to those that have been previously purchased by the members of the customer group. In some cases, the sales promotion may involve an exchange of reward points. In some cases, determining a sales promotion may include identifying a time period that historically has relatively low sales rates, and defining the sales promotion to be effective only during that time period.

FIG. 3 illustrates an example method 300 of performing the action 212 of determining or selecting a sales promotion for a particular customer group. An action 302 of the method 300 comprises identifying one or more products, which may in some cases include a category of products, that are to be the subject of the sales promotion. The action 302 may be based on past purchase or purchasing behaviors of the members of the customer group, on the business type of the merchant, and/or on the specified sales priorities of the merchant. In addition, the action 302 may be based on the current inventory of the merchant and other factors such as the profit margin for various inventoried products of the merchant, the age or upcoming expiration of the products, the newness of the products to the merchant inventory, and so forth.

As one example, the products selected in the action 302 may comprise or be similar to products or product categories that the selected customer group has previously purchased, particularly in the case where the customer group is defined based on past purchases. As another example, the products selected in the action 302 may comprise products different than those previously purchased by members of the selected customer group, in order to encourage sales of different products.

Products for sales promotions may be selected based on the business type of the merchant. For example, for merchants that sell perishable products, products may be selected so as to encourage sales of products that are nearing expiration. As another example, products may be selected based on current popularity of the products as determined based on social media indicators or other measures of popularity.

Products for sales promotions may also be selected based on specified sales priorities of the merchant. For example, a merchant may specify a priority of selling certain types of products, of selling normally slow-selling products, of selling new products, etc.

Products for sales promotions may be selected based on current merchant inventories. For example, products having unusually or undesirably high inventory counts may be selected. Products may also be selected based on profit margins, with priority given to products having higher profit margins in order to increase profits of the merchant.

An action 304 comprises determining an incentive that will be offered as part of the sales promotion. An incentive may comprise a discount, a bundled discount, a conditional discount, an award of bonus reward points, etc. Discounts may in some cases be offered for redemption of reward points.

Returning to FIG. 2, an action 214 comprises recommending the sales promotion to the merchant 102. The recommendation includes both the determined or selected sales promotion and an identification of the customer group that is to receive the sales promotion. As an example, the merchant may be notified by an appropriate user interface element of the merchant dashboard 148. In response to the notification, the merchant may select and/or approve the selected sales promotion. In some embodiments, the merchant may be allowed to modify the sales promotion, such as by modifying the amount of a discount, the offered product(s), etc.

An action 216 comprises sending notifications regarding the sales promotion to members of the selected customer group, wherein the notifications describe the sales promotion. For example, the action 216 may comprise sending an email to recorded email addresses of the customers of the selected customer group. The action 216 may alternatively comprise a more immediate type of notification, such as a text message or some other type of message that generates a visual and/or audio alert on the mobile device 116 of the customer 104. As an alternative, an alert may be generated by communicating with the client application 146, which may be configured to present a visual or audio indication perceptible to the customer 104, and to prompt the customer 104 to open a communication or other user interface element to view details of the sales promotion.

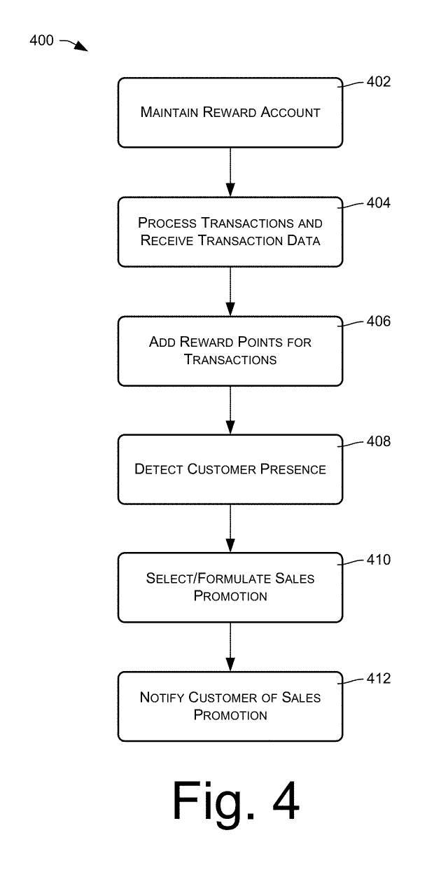

FIG. 4 illustrates an example method 400 of implementing and communicating sales promotions in conjunction with reward point accounts, which are sometimes referred to as loyalty programs. A merchant may grant reward points to customers when the customers visit the merchant and/or purchase products from the merchant, or for other events or promotional purposes. Generally, the points are redeemable for discounts when purchasing additional products. In the example method 400, a sales promotion is selected and offered based on characteristics of an individual customer, such as the number of reward points held by the customer.

An action 402 comprises maintaining a reward account for each of multiple customers of the merchant. The reward account for a particular customer indicates the current number of reward points of the customer. In the context of FIG. 1, the reward accounts may be maintained by the points and promotions module 142, for example.

An action 404 comprises processing purchase transactions, which may include receiving, creating, and storing transaction data. The action 404 may include, for example, receiving transaction data at the transaction service 108 from the POS device 106. Stored transaction data may also include data created and/or defined by the transaction service 108 as part of processing purchase transactions.

An action 406 comprises adding reward points to the reward accounts of individual customers in accordance with transaction amounts of transactions conducted between the merchant and the individual customers. Reward points may be added proportionally to transaction amounts, proportionally to the numbers of products purchased by the customer, for numbers of visits to the merchant, and/or on any other basis desired by the merchant or specified by sales promotions offered to the customers.

An action 408 comprises determining that the customer is at the business establishment of the merchant. As one example, the action 408 may comprise receiving a communication from the customer mobile device 116 that the customer 104 is at the business establishment of the merchant 102. The client application 146, for example, may be configured to execute as a background process on the customer device 116, to monitor the location of the customer device using GPS (global positioning system) components of the customer device 116, and to thereby detect the presence of the customer 104 within the merchant's business establishment. Upon detecting that the customer 104 is within the merchant's business establishment, the customer device 116 may notify the transaction service 108.

As another example, the action 408 may comprise receiving a location “check-in” from the customer 104 through the customer device 116. More specifically, upon arriving at the merchant's business location, the customer may use the client application 146 to indicate the customer's presence at the merchant's business location. In this case, the client application 146 may comprise a social networking application, as an example. Alternatively, the client application 146 may comprise a special-purpose application provided by the merchant 102 for communications with customers through their mobile devices.

Alternatively, the merchant POS device 106 may have or may be associated with hardware and/or software for detecting the presence of the customer device 116 and for reporting the detected presence to the transaction service 108. For example, the client application 146 may be an application that is configured to connect to a wireless local-area network of the merchant 102 and upon connection to report its presence. As another example, the merchant POS device 106 may use various types of beacon technologies, such as technologies that use BLE (Bluetooth Low Energy), that enable the mobile device 116 to detect and report its location within a business establishment.

Upon determining that a customer is at or within the business establishment of the merchant, an action 410 may be performed of selecting and/or formulating a sales promotion to be offered to the customer. The action 410 may be performed in accordance with the method 300 of FIG. 3. In this case, the incentive that is determined or selected in the action 204 may involve reward points. That is, the incentive may be a discount that is obtained by redeeming reward points or may comprise an award of bonus reward points for purchasing specified products.

The action 410 may be based at least in part on the number of reward points currently in the reward point account of the customer. Specifically, a sales promotion offered to a specific customer may involve redemption of a number of reward points, and the parameters of the sales promotion may be selected so that the number of reward points does not exceed the points that are currently held by the customer. Furthermore, sales promotions involving higher-priced products may be offered to customers having relatively higher reward points balances.

An action 412, performed in response to determining that the customer is at the business establishment of the merchant, comprises notifying the customer of the sales promotion. The action 412 may comprise sending a real-time or near-real-time notification to the device 116 of the customer 104, such as a text message. The action 412 may in some cases comprise sending an email to the customer. The action 216 may comprise a message or communication that generates a visual and/or audio alert on the mobile device 116 of the customer 104. In some cases, an alert may be generated by communicating with the client application 146, which may be configured to present a visual or audio indication perceptible to the customer 104, and to prompt the customer 104 to open a communication or other user interface element to view details of the sales promotion.

After receiving the notification of the sales promotion, the customer may take advantage of the promotion by purchasing one or more products specified by sales promotion. Upon checkout, the POS device 106 in combination with the transaction service 108 may determine the identity of the customer 104, determine that a sales promotion was offered to the customer, and may automatically fulfill the terms of the sales promotion. This may comprise awarding or redeeming reward points.

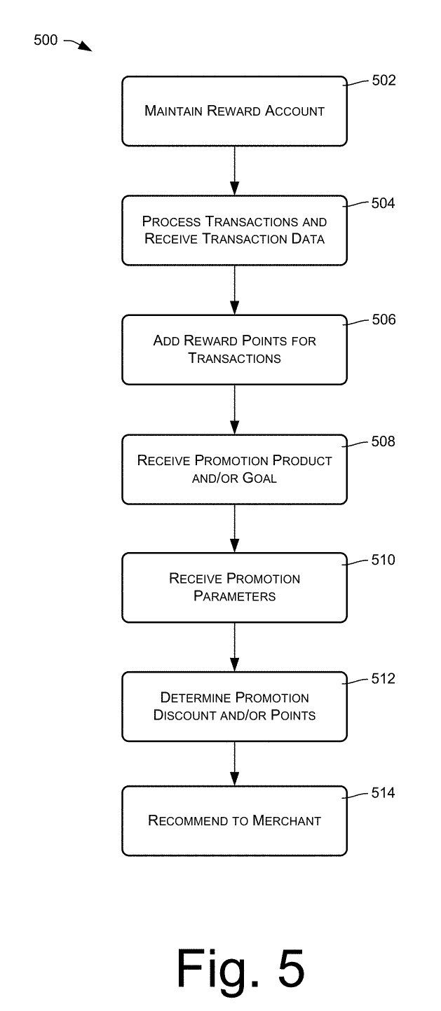

FIG. 5 illustrates an example method 500 of recommending one or more promotion values to a merchant. In the described embodiment, the promotion values include a determined number of reward points that are to be redeemed in order to obtain a corresponding discount. In some embodiments, the promotion values may include the price discount itself, although in other parameters the merchant may specify a desired price discount. Note that a merchant may specify a 100% price discount, which means that the product will be free in exchange for the corresponding number of reward points.

An action 502 comprises maintaining a reward account for each of multiple customers of the merchant. The reward account for a particular customer indicates the current number of reward points of the customer. In the context of FIG. 1, the reward accounts may be maintained by the points and promotions module 142, for example.

An action 504 comprises processing purchase transactions, which may include receiving, creating, and storing transaction data. The action 504 may include, for example, receiving transaction data at the transaction service 108 from the POS device 106. Stored transaction data may also include data created and/or defined by the transaction service 108 as part of processing purchase transactions. The transaction data may be for transactions conducted by a single merchant or for transactions conducted by multiple merchants.

An action 506 comprises adding reward points to the reward accounts of individual customers in accordance with the transaction data. In some cases, the reward points may be added based on transaction amounts of transactions conducted between the merchant and the individual customers. Reward points may be added proportionally to transaction amounts, proportionally to the numbers of products purchased by the customer, for numbers of visits to the merchant, and/or on any other basis desired by the merchant or specified by sales promotions offered to the customers.

An action 508 comprises receiving, from the POS device 106 or other device associated with a merchant, an identification of a promotion goal of the merchant. The promotion goal may indicate a product that is to be offered in exchange for redemption of an as-yet unspecified and yet to be determined number of reward points. The promotion goal may specify other information, such as a target number of customers that the merchant desires to redeem the reward points to obtain the specified product.

An action 510 comprises receiving one or more promotion parameters from the merchant device, wherein the promotion parameters specify desired characteristics or limits of a sales promotion. As examples, the promotion parameters may include one or more of the following, without limitation:
a desired price discount for the specified product;
a maximum price discount for the product;
a minimum price discount for the product;
a maximum price discount for the product;
a type of customer for which the sales promotion is to be effective;
a desired minimum for the determined number of reward points;
a desired maximum for the determined number of reward points;
etc.

An action 512 comprises determining the number of reward points that a customer will need to redeem in order to obtain a discount on the product. This number will be referred to herein as the promotion points number.

The action 512 may also in some cases comprises determining the price discount, although in other cases the merchant may provide a desired price discount as part of the promotion parameters.

The action 512 is performed with the objective of determining a promotion points number that in combination with the price discount is likely to achieve the promotion goals of the merchant as specified in the action 508. The action 512 may, for example, be based at least in part on the current numbers of reward points held by the customers of the merchant. Specifically, the promotion points number may be selected to ensure that at least a certain number of the merchant's customers have reward points that are equal to or that exceed the promotion points number, so that this number of customers is eligible to participate in the promotion.

The action 512 may also in some embodiments include predicting a number of customers that will or that are likely to redeem their reward points to obtain the sale product, and selecting the promotion points number so that at least a desired number of customers, as specified by the promotion goals, will likely obtain the product by redemption of reward points. The predicting may be based on analyzing historical transaction data and reward points redemptions to determine the responsiveness of customers to promotions involving differing combinations of price discounts and promotion points numbers. This historical transaction data may be for transactions conducted by the merchant and in some cases may also be for transactions conducted by other merchants. As an example it may be found upon analysis that typically around 50% of eligible customers (those having the requisite number of reward points) will redeem their points to take advantage of a sales promotion having given characteristics and parameters. This analysis may be a general analysis, or may be differentiated by different types of products, business, customers, etc.

In some cases, the action 512 may comprise determining a sales promotion by selecting a product, a price discount, and a promotion points number. The product and discount may be selected based on inventory levels, undiscounted pricing, costs of the products to the merchant, desired profit margins, merchant business type, merchant business objectives, and/or upon the specific promotion goals and parameters provided by the merchant.

An action 514 comprises providing the price discount and/or promotion points number to the merchant or merchant device as a recommendation for a sales promotion. The merchant may accept the recommended discount and/or promotion points number, and the transaction service 108 may thereupon implement the promotion on behalf of the merchant.

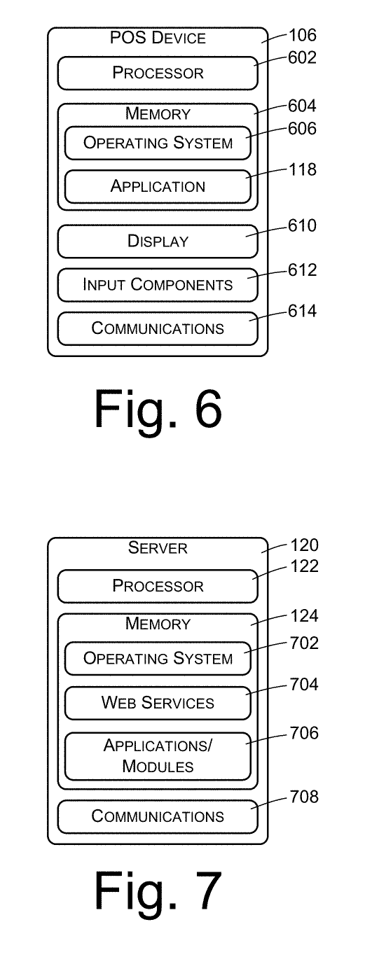

FIG. 6 shows an example of a POS device 106 that may be used in the environment described herein. Generally, the POS device 106 may comprise any type of computerized device that has or can be associated with a graphical display upon which visual content can be shown. Examples of such devices include personal computers, smartphones, tablet computers, laptop computers, projection systems, television systems, and so forth.

In the illustrated example, the POS device 106 includes at least one processor 602 and associated memory 604. Each processor 602 may itself comprise one or more processors or processing cores. For example, the processor 602 can be implemented as one or more microprocessors, microcomputers, microcontrollers, digital signal processors, central processing units, state machines, logic circuitries, and/or any devices that manipulate signals based on operational instructions. In some cases, the processor 602 may be one or more hardware processors and/or logic circuits of any suitable type specifically programmed or configured to execute the algorithms and processes described herein. The processor 602 can be configured to fetch and execute computer-readable processor-executable instructions stored in the memory 604.

Depending on the configuration of the POS device 106, the memory 604 may be an example of tangible non-transitory computer storage media and may include volatile and nonvolatile memory and/or removable and non-removable media implemented in any type of technology for storage of information such as computer-readable processor-executable instructions, data structures, program modules or other data. The memory 604 may include, but is not limited to, RAM, ROM, EEPROM, flash memory, solid-state storage, magnetic disk storage, optical storage, and/or other computer-readable media technology. Further, in some cases, the POS device 106 may access external storage, such as RAID storage systems, storage arrays, network attached storage, storage area networks, cloud storage, or any other medium that can be used to store information and that can be accessed by the processor 602 directly or through another computing device or network. Accordingly, the memory 604 may be computer storage media able to store instructions, modules or components that may be executed by the processor 602. Further, when mentioned, non-transitory computer-readable media exclude media such as energy, carrier signals, electromagnetic waves, and signals per se.

The memory 604 may be used to store and maintain any number of functional components that are executable by the processor 602. In some implementations, these functional components comprise instructions or programs that are executable by the processor 602 and that, when executed, implement operational logic for performing the actions and services attributed above to the POS device 106.

In the context of the examples described above, functional components of the POS device 106 stored in the memory 604 may include an operating system 606 for controlling and managing various functions of the POS device 106. The memory 604 may also store the merchant support application 118 that provides POS functionality and other functionality described herein for the POS device 106. The memory 604 may also store additional data, data structures, and the like, not shown, that are used in the course of operations of the POS device 106 and its components.

The POS device 106 may have or be associated with a display component 610 upon which received content is displayed. The display component 610 may be integral to the POS device 106 or may be connected to or otherwise associated with the POS device 106.

The POS device 106 may have various input components 612, which may include a keyboard, a mouse, a stylus, a touch screen, etc. One or more of the input components may be used to perform selection of control elements within displayed content.

The POS device 106 may have a network communications interface 614, such as an Ethernet communications interface or Wi-Fi communications interface, which provides communication by the POS device 106 with various network-based or Internet-based servers, including the transaction service 108.

The POS device 106 may of course include many other logical, programmatic, and physical components that are not specifically described herein.

FIG. 7 shows an example of one of the server computers 120. In the illustrated example, each server computer 120 includes at least one processor 122 and associated memory 124. Each processor 122 may itself comprise one or more processors or processing cores. For example, the processor 122 can be implemented as one or more microprocessors, microcomputers, microcontrollers, digital signal processors, central processing units, state machines, logic circuitries, and/or any devices that manipulate signals based on operational instructions. In some cases, the processor 122 may be one or more hardware processors and/or logic circuits of any suitable type specifically programmed or configured to execute the algorithms and processes described herein. The processor 122 can be configured to fetch and execute computer-readable processor-executable instructions stored in the memory 124.

Depending on the configuration of the server computer 120, the memory 124 may be an example of tangible non-transitory computer storage media and may include volatile and nonvolatile memory and/or removable and non-removable media implemented in any type of technology for storage of information such as computer-readable processor-executable instructions, data structures, program modules or other data. The memory 124 may include, but is not limited to, RAM, ROM, EEPROM, flash memory, solid-state storage, magnetic disk storage, optical storage, and/or other computer-readable media technology. Further, in some cases, the server computer 120 may access external storage, such as RAID storage systems, storage arrays, network attached storage, storage area networks, cloud storage, or any other medium that can be used to store information and that can be accessed by the processor 122 directly or through another computing device or network. Accordingly, the memory 124 may be computer storage media able to store instructions, modules or components that may be executed by the processor 122. Further, when mentioned, non-transitory computer-readable media exclude media such as energy, carrier signals, electromagnetic waves, and signals per se.

The memory 124 may be used to store and maintain any number of functional components that are executable by the processor 122. In some implementations, these functional components comprise instructions or programs that are executable by the processor 122 and that, when executed, implement operational logic for performing the actions and services attributed above to the transaction service 108.

Functional components of the server 120 stored in the memory 124 may include an operating system 702 for controlling and managing various functions of the server 120. The memory 124 may also store a web services component 704. The web services component 704 is responsible for receiving content requests from various networked client devices and providing content in response to such requests. The memory 124 may also store various applications and/or modules 706, which may include the various software modules of the server computer 120 described above with reference to FIG. 1.

The server 120 may have a network communications interface 708, such as an Ethernet communications interface, which provides communication by the server 120 with other servers and with client devices such as the POS device 106.

The server 120 may of course include many other logical, programmatic, and physical components that are not specifically described herein.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method performed by one or more computers of a payment processing system, the method comprising:
maintaining, at the one or more computers of the payment processing system, a reward account for each of multiple customers of a merchant, the reward account indicating a current number of reward points of each customer;
receiving transaction data at the one or more computers of the payment processing system from a mobile point-of-sale (POS) device associated with the merchant, the transaction data indicating (a) transaction amounts for respective purchase transactions and (b) products purchased by individual customers;
adding reward points to the reward account of a customer in accordance with the transaction data;
receiving a promotion goal of the merchant from the POS device, wherein the promotion goal specifies (a) a product that is to be offered in exchange for redeeming reward points and (b) a target number of customers to obtain the product in exchange for redeeming the reward points;
determining a number of the reward points that will be redeemable to obtain the product, wherein at least the target number of customers each has at least the determined number of reward points; and
sending the determined number of reward points to the POS device as a first recommendation for a sales promotion that is likely to achieve the promotion goal of the merchant.

2. The method of claim 1, further comprising receiving one or more promotion parameters from the POS device, the promotion parameters comprising one or more of:
a desired price discount for the product;
a maximum price discount for the product;
a minimum price discount for the product;
a maximum cost to the merchant of the sales promotion;
a type of customer for which the sales promotion is to be effective;
a desired minimum for the determined number of reward points; or
a desired maximum for the determined number of reward points.

3. The method of claim 1, further comprising:
determining a price discount for the product;
sending the price discount to the POS device as a second recommendation for the sales promotion.

4. The method of claim 1, further comprising analyzing historical transaction data to determine a predicted number of customers that will redeem the determined number of reward points to obtain the product, wherein determining the number of reward points is based at least in part on the predicted number of customers.

5. The method of claim 4, wherein the historical transaction data is for transactions conducted by the merchant and for transactions conducted by other merchants.

6. A system, comprising:
one or more processors;
one or more non-transitory computer-readable media storing instructions executable by the one or more processors, wherein the instructions program the one or more processors to perform actions comprising:
maintaining a reward account for a customer of a merchant, the reward account indicating a current number of reward points of the customer;
receiving an indication of at least one product from a merchant device associated with a merchant;
determining a sales promotion for the particular product, wherein the sales promotion comprises (a) a price discount for the particular product and (b) a determined number of reward points that will be redeemable by the customer to obtain the price discount; and
sending the sales promotion to the merchant device as a recommendation to the merchant.

7. The system of claim 6, further comprising:
receiving one or more promotion parameters from the merchant device, the promotion parameters comprising one or more of:
a desired price discount for the product;
a maximum price discount for the product;
a minimum price discount for the product;
a maximum cost to the merchant of the sales promotion;
a type of customer for which the sales promotion is to be effective;
a desired minimum for the determined number of reward points; or
a desired maximum for the determined number of reward points;
wherein determining the sales promotion is based at least in part on the one or more promotion parameters.

8. The system of claim 6, further comprising determining the number of reward points based at least in part on how many reward points are held by each of multiple customers.

9. The system of claim 6, further comprising:
determining how many of multiple customers have at least the determined number of reward points; and
predicting how many of the multiple customers are likely to redeem the number of reward points to obtain the product.

10. The system of claim 9, wherein predicting how many of the multiple customers are likely to redeem the number of reward points is based at least in part on analyzing historical reward points redemptions by customers of the merchant and by customers of other merchants.

11. The system of claim 6, further comprising receiving a promotion goal from the merchant device, wherein determining the sales promotion comprises determining a combination of the price discount and the number of reward points that is likely to achieve the promotion goal.

12. The system of claim 11, wherein:
the promotion goal comprises of a target number of customers that will redeem the number of reward points to obtain the product; and
determining the number of reward points comprises determining how many of multiple customers have at least the number of reward points.

13. The system of claim 11, wherein:
the promotion goal comprises a target number of customers to redeem the determined number of reward points to obtain the product; and
determining the number of reward points comprises (a) determining how many of multiple customers have at least the number of reward points and (b) predicting how many of the multiple customers are likely to redeem the determined number of reward points to obtain the product.

14. A method comprising:
maintaining reward accounts for customers of a merchant, the reward accounts indicating current numbers of reward points of the customers;
receiving an indication from a device associated with the merchant of at least one product to be offered in a sales promotion in exchange for redemption by a customer of reward points;
determining a first number of reward points that will be redeemable to obtain the product based at least in part on the current numbers of reward points; and
sending an indication of the first number of reward points to the device associated with the merchant as a recommendation to the merchant for the sales promotion.

15. The method of claim 14, further comprising:
receiving a target number of customers that are to redeem reward points to obtain the product; and
wherein determining the first number of reward points comprises determining how many of the customers have at least the first number of reward points.

16. The method of claim 14, further comprising receiving a promotion goal from the device, further comprising determining a combination of a price discount and the first number of reward points that is likely to achieve the promotion goal.

17. The method of claim 14, further comprising:
receiving one or more promotion parameters from the device, the promotion parameters comprising one or more of:
a desired price discount for the product;
a maximum price discount for the product;
a minimum price discount for the product;
a maximum cost to the merchant of the sales promotion;
a type of customer for which the sales promotion is to be effective;
a desired minimum of the number of reward points; or
a desired maximum of the number of reward points;
wherein determining the first number of reward points is based at least in part on the one or more promotion parameters.

18. The method of claim 14, further comprising:
determining how many customers have at least the first number of reward points; and
predicting how many of customers are likely to redeem the first number of reward points to obtain the product.

19. The method of claim 18, further comprising receiving an indication from the device of a target number of customers to redeem reward points to obtain the product.

20. The method of claim 18, wherein predicting how many of the customers are likely to redeem the first number of reward points to obtain the product comprises analyzing historical reward points redemptions by customers of the merchant and by customers of other merchants.
